(19) United States
(12) Patent Application Publication
(10) Pub. No.: US 2025/0193930 A1
(43) Pub. Date: Jun. 12, 2025

(54) METHOD AND APPARATUS FOR SAFETY ENHANCING TRANSMISSION IN A V2X ENVIRONMENT

(71) Applicant: AUTOTALKS LTD., Kfar Netter (IL)

(72) Inventors: Leonid Menis, Kfar Netter (IL); Eyal Nahum, Kfar Netter (IL)

(21) Appl. No.: 18/536,293

(22) Filed: Dec. 12, 2023

(51) Int. Cl. H04W 74/0816; H04W 72/02; H04W 74/04; H04W 74/08

(52) U.S. Cl. CPC H04W 74/0816; H04W 72/02; H04W 74/04; H04W 74/0866

(57) ABSTRACT

Method and apparatus for enhancing transmission safety in a vehicle-to-everything (V2X) environment. A method comprises, by an ego-vehicle, identifying a safety-critical vehicle in the vicinity of the ego-vehicle, identifying interferers in proximity to the safety-critical vehicle, estimating transmission time slots of each identified interferer based on past transmissions of the respective identified interferer, and transmitting in a time slot that minimizes the probability of an over-the-air collision with any of the identified interferers. The apparatus is a modified V2X communication unit that includes a modified MAC layer and a V2X stack, wherein the V2X stack is configured to perform the abovementioned identifying actions and wherein the modified MAC layer is configured to perform the abovementioned estimating and transmitting actions.

### FIELD

Embodiments disclosed herein relate generally to vehicle-to-everything (V2X) communications, and in particular to a method and apparatus (system) for enhancing the reliability of safety-critical V2X communications by an ego-vehicle (or “self-vehicle”)

### BACKGROUND

V2X messages are used to share safety-critical information between road users (all types of vehicles, bike riders, vehicular environment infrastructure, etc.) in driving environments. Such safety-critical information may include location, speed, heading, and planned maneuver trajectory of the road users. The description below uses vehicles as exemplary road-users, with the understanding that methods and systems disclosed herein apply as well to road users other than vehicles. All described actions are performed in an ego-vehicle.

In many scenarios, a message from a vehicle farther from a given vehicle (“far vehicle”) is more important for safety than a message from a vehicle nearer to the given vehicle (“near vehicle”).

FIG. 1 illustrates an example of a safety scenario in which vehicles drive on a two-way one-lane road. A vehicle 102 attempts to overtake truck 104. To prevent a frontal collision between vehicle 102 and a vehicle 106 (here an ego-vehicle), a message from vehicle 106 (referred to as “safety-critical message”) is much more important to vehicle 102 than messages received from an adjacent (to vehicle 102) vehicle 108. In the following, a vehicle like ego-vehicle 106, which transmits safety-critical messages, is referred to as “source”. A vehicle like vehicle 102, which is the most safety-critical recipient of messages, is referred to as “target”, and a vehicle like vehicle 108 is referred to as “interferer”.

Without any countermeasure, there is some probability that the messages from both the source (far vehicle 106) and from the interferer (much closer or “near” vehicle) 108, will reach the target vehicle 102 at the same time. A high number of vehicles in the vicinity of the target vehicle will increase that probability. Since interferer vehicle 108 is closer to target vehicle 102 than source 106, the power level of a message received in target vehicle 102 from interferer vehicle 108 is much higher (see FIG. 2). Above certain differences in power levels between messages from the source and the interferer, it will not be possible for the target to correctly receive the message from the source.

Three main V2X communication standards are expected to be in mass deployment in the next few years: ETSI ITS-G5 (DSRC), 3GPP LTE-V2X and 3GPP NR-V2X. Each V2X standard will be used in a different frequency channel, though those frequency channels are adjacent. With increased penetration vehicles are expected to use all of the standards. For example, in the European Union (EU) vehicles are expected to use the following standards combinations: only ITS-G5 (DSRC), only NR-V2X, or operating concurrently on both channels allocated to ITS-G5 (DSRC) and NR-V2X. In the US and China, vehicles are expected to use only LTE-V2X or operate concurrently on both channels allocated to LTE-V2X and NR-V2X.

In the planned deployments, the following interference modes are expected due to the near-far problem: in-band near-far reception issues on C-V2X channels (LTE-V2X and NR-V2X); and reception issues due to the interferer on an adjacent channel. The in-band near-far reception issue is that 3GPP CV2X specifications allow for several road users to transmit at the same time slots, as long as they use different frequency resources.

FIG. 2 illustrates multi-user transmission according to the 3GPP C-V2X specification. The figure shows in-band interference, due to concurrent transmission in the same band using different frequency resources. This is allowed by the 3GPP standards. The concurrent over-the-air duration of the messages (i.e. the fact that the standard allows two messages being sent concurrently) is a problem in some cases.

FIG. 3 illustrates the power imbalance at the receiver of the target showing the near-far problem (also referred to as “co-channel near-far problem”). The power imbalance shows that the interfering message at the receiver may be much stronger than the safety-critical message, thus preventing proper reception by the target vehicle of the more important message.

FIG. 4 illustrates the adjacent channel interference problem, i.e. the problem where the transmission is happening on a neighboring frequency band, but still can cause a problem, due to wider band RF components in the Rx chain.

Operation on different frequency channels can result in a situation where transmission from the source in one channel overlaps with the transmission from the interferer in the other. The interference from the adjacent channel can occur when the ego-vehicle operates using ITS-G5 radio or C-V2X radio. This is due to the fact that there is no standard/industry specification on how to prevent such an over-the-air interference and coordinate multi-channel operation (see FIG. 4). The result is similar to the situation of the co-channel near-far problem (FIG. 3). The target receiver cannot handle the reception of the important but weak message from the source in the presence of a much stronger message from the interferer. The problem is worsened by the fact that in a congested scenario, the transmission interval between messages is decreased, making each message more valuable.

### SUMMARY

Embodiments disclosed herein refer to methods for enhancing the reliability of safety-critical V2X communication by the ego-vehicle. The methods aim to minimize the likelihood of failed reception of a safety-critical message at the target vehicle due to interference, thereby ensuring the safety of the target vehicle, for which the transmitted V2X message is the most important. By implementing intelligent scheduling techniques, the ego-vehicle optimizes the transmission timing of the safety-critical message to mitigate potential interference and improve overall V2X system robustness. This innovation enhances protection for occupants and other road users in critical situations.

A key aspect of this approach lies in the utilization of information from the uppermost layer of the V2X stack, where the classification of detected vehicles based on safety relevance takes place. By utilizing this cross-layer information, the transmission slots of the lowest layer (radio) are scheduled intelligently and resulting in optimized safety-critical communication.

In various exemplary embodiments there are provided methods in which an ego-vehicle adjusts the transmission timing of messages in such a way that it will minimize the chances of the messages being interfered with at the most safety-critical vehicle and thus maximize successful reception probability. It is assumed that the ego-vehicle knows the locations of surrounding vehicles and can identify the vehicles to whom its messages are most important; receives the messages from interferer vehicles and can estimate when they will transmit again, based on their past transmissions; in case of concurrent multi-channel operation, the ego-vehicle has the capability for a concurrent reception on both frequency channels and can adjust the transmitting timing of its messages.

The ego-vehicle will schedule its transmission so that it will not overlap with the estimated transmission times of interfering vehicles. The solution shall be different, depending if the ego-vehicle plans to transmit on a channel allocated to C-V2X technology or ITS-G5 technology.

In various exemplary embodiments, in a V2X environment, there is provided a method comprising: by an ego-vehicle: identifying a safety-critical vehicle in the vicinity of the ego-vehicle; identifying interferers in proximity to the safety-critical vehicle; estimating transmission time slots of each identified interferer based on past transmissions of the respective identified interferer; and transmitting in a time slot that minimizes the probability of an over-the-air collision with any of the identified interferers, whereby the method enhances transmission safety.

In some examples, the transmitting in a time slot that minimizes the probability of an over-the-air collision with any of the identified interferers includes scheduling a transmission time slot which does not overlap with the estimated interferer transmission time slots and transmitting in the scheduled transmission time slot. In some examples, the transmission is on a C-V2X channel, and the estimating the transmission slots of each identified interferer includes: (i) identifying time slots during which each identified interferer is expected to transmit on the same channel as the ego-vehicle, (ii) identifying all time slots during which each respective identified interferer is expected to transmit on a channel adjacent to the one on which the ego-vehicle transmits, based on past transmission times of the respective identified interferer, (iii) identifying all possible transmission resources per a resource selection procedure, and (iv) selecting an identified transmission resource while excluding slots identified in (i) and (ii).

In some examples, the transmission is on an ITS-G5 channel, and the estimating the transmission slots of each identified interferer includes identifying time slots during which each identified interferer is expected to transmit on the same channel as the ego-vehicle, attempting a transmission using an ITS-G5 MAC channel access procedure, treating all identified time-slots as channel busy, and checking whether the transmission was successful in a configurable pre-defined interval.

In some examples, if the transmission was not successful in the configurable pre-defined interval, the transmitting in a time slot includes transmitting according to an ITS-G5 standard defined transmission procedure.

In various exemplary embodiments, there is provided a modified V2X communication unit installed in an ego-vehicle and comprising: a radio transceiver for transmitting and receiving messages, and a V2X processor operatively coupled with the radio transceiver and comprising a PHY layer, a modified MAC layer and a V2X stack, wherein the V2X stack is configured to identify a safety-critical vehicle in the vicinity of the ego-vehicle and to identify interferers in proximity to the safety-critical vehicle, and wherein the modified MAC layer is configured to estimate transmission time slots of each identified interferer based on past transmissions of the respective identified interferer, and to transmit in a way that the transmission minimizes the probability of an over-the-air collision with any of the identified interferers.

In some examples, the configuration of the modified MAC layer to estimate transmission time slots of each identified interferer based on past transmissions of the respective identified interferer, and to transmit in a way that minimizes the probability of an over-the-air collision with any of the identified interferers includes a configuration to schedule a transmission time slot which does not overlap with the estimated interferer transmission time slots and to transmit in the scheduled transmission time slot.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1 illustrates an example of a safety scenario;

FIG. 2 illustrates multi-user transmission according to the 3GPP C-V2X specification;

FIG. 3 illustrates the near-far problem, showing the power imbalance at the receiver of the target;

FIG. 4 illustrates the adjacent channel interference problem;

FIG. 5 illustrates in a flowchart an embodiment of a method disclosed herein;

FIG. 6 illustrates in a flowchart sub-steps of step 506 of FIG. 5, when operating on the C-V2X channel;

FIG. 7 illustrates in a flowchart sub-steps of step 506, when operating on the ITS-G5 channel;

FIG. 8 shows an exemplary embodiment of an apparatus for performing a method disclosed herein.

### DETAILED DESCRIPTION

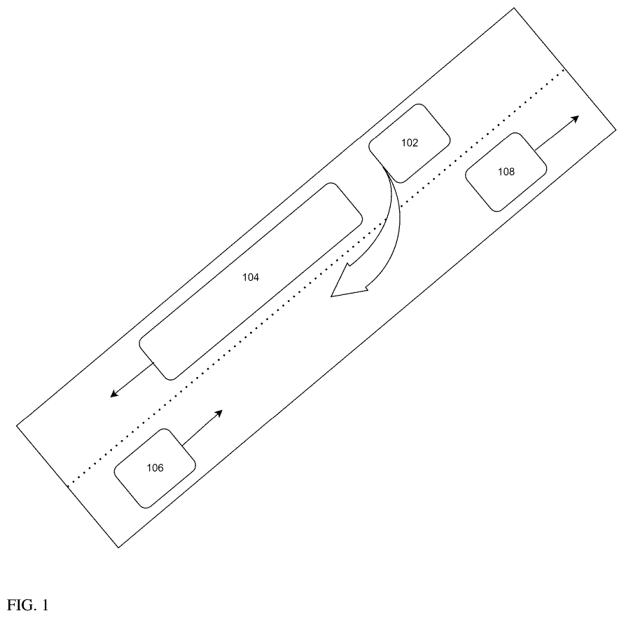

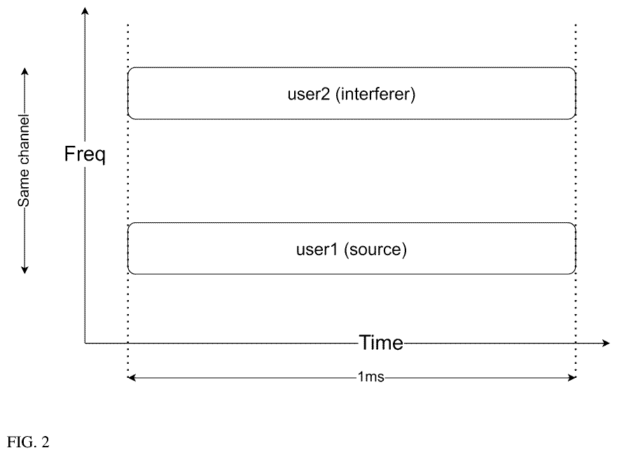

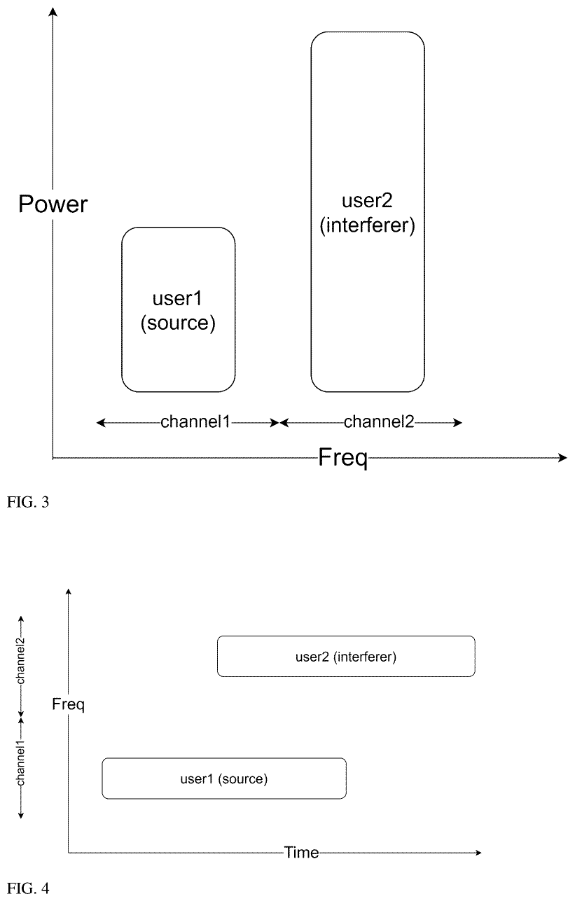

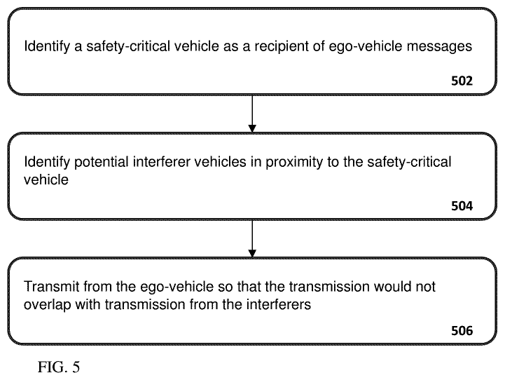

FIG. 5 illustrates in a flowchart an exemplary embodiment of a method disclosed herein. All actions (steps) are performed in an ego-vehicle (the source). The method may address different driving scenarios, for example: a) a driving scenario as in FIG. 1, in which a safety-critical recipient of ego-vehicle 102 messages is vehicle 102 behind truck 104; b) an intersection scenario, in which safety-critical recipients of ego-vehicle messages are the vehicles or vulnerable road users approaching the intersection on a collision path; or c) a “hard braking event” scenario, in which the ego-vehicle brakes abruptly and the safety-critical vehicles are those just behind it.

In step 502, based on the driving scenario, the ego-vehicle identifies one or more vehicles (and more generally road-users) in its communication range (“vicinity”) that are the most safety-critical recipients of its messages. Such vehicles are referred to as “safety-critical” vehicles. Assume one such safety-critical vehicle was identified. In step 504, the ego-vehicle identifies all potential interferers in proximity to the safety-critical vehicle, which, if transmitting, would likely interfere with the reception by the safety-critical vehicle of ego-vehicle messages. “Proximity” is defined as the distance from the target vehicle within which the signal strength from potential interferers at target vehicle receiver surpasses a set threshold. In step 506, the ego-vehicle estimates the transmission time slots of the interferers based on past transmissions of each interferer, and transmits in a way that the transmission would not overlap with transmission from the interferers.

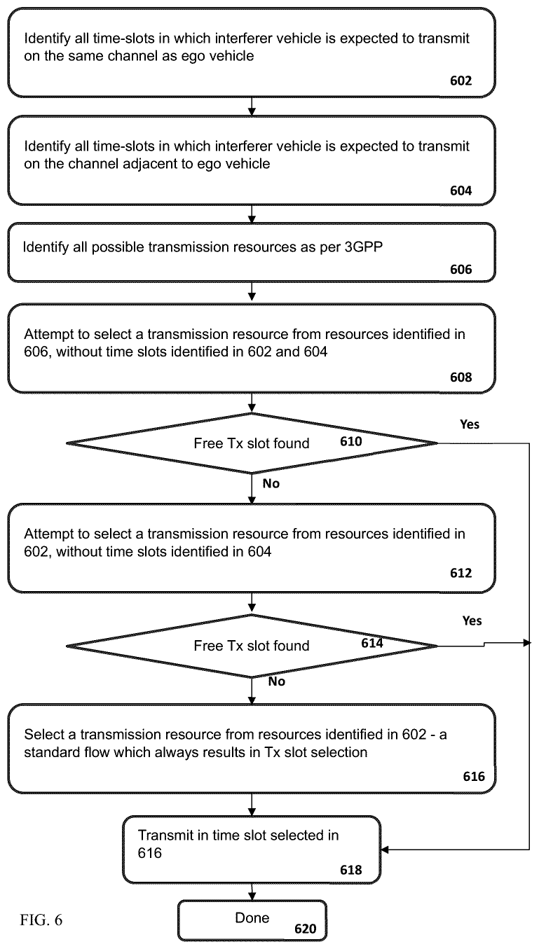

FIG. 6 illustrates in a flowchart sub-steps of step 506 of FIG. 5, when operating on the C-V2X channel. All steps are performed in (and by) the ego-vehicle. In step 602, the ego-vehicle implements the standard defined resource selection procedure, and identifies time slots during which interferer vehicles are expected to transmit on the same channel as the ego-vehicle. In step 604, the ego-vehicle identifies all time slots during which interferer vehicles are expected to transmit on the adjacent channel, based on past transmission times. In step 606, the ego-vehicle identifies all possible transmission resources as per 3GPP. In step 608, the ego-vehicle selects a transmission resource identified in step 606, without (i.e. not using) time slots identified in steps 602 and 604.

Note that in contrast with known transmission schemes as allowed by communication standards, which allow transmission whenever the channel is expected to be free, here transmission is attempted whenever the channel is expected to be free and whenever the chance of reception by a safety-critical vehicle is the highest. This is done without violating the standard, since a user (i.e. the ego-vehicle or its driver) still restricts itself to the “channel-free” condition.

In step 610, a check is made to see whether a free TX slot is found. In case the implementation does not leave the ego-vehicle sufficient freedom to schedule a transmission without creating an unacceptably long interval between consecutive transmissions, the ego-vehicle will first ignore interference on the adjacent channel. If there is still no possibility to schedule the transmission, the ego-vehicle shall ignore the interferers completely (fall back to regular TX scheduling).

If a free TX slot is found in step 610, then a message is transmitted in the free TX slot in step 618. If a free TX slot is not found in step 610, then in step 612 the ego-vehicle attempts to select a transmission resource from resources identified in step 602, without (i.e. excluding) time slots identified in step 604. In a check step 614, if a free TX slot is found among the transmission resource selected in step 612 then a message is transmitted in the free TX slot in step 618. If a free TX slot is not found in step 614, then in step 616 the ego-vehicle selects a transmission resource from resources identified in step 602, and a message is transmitted in the free TX slot in step 618. The operation then ends in step 620.

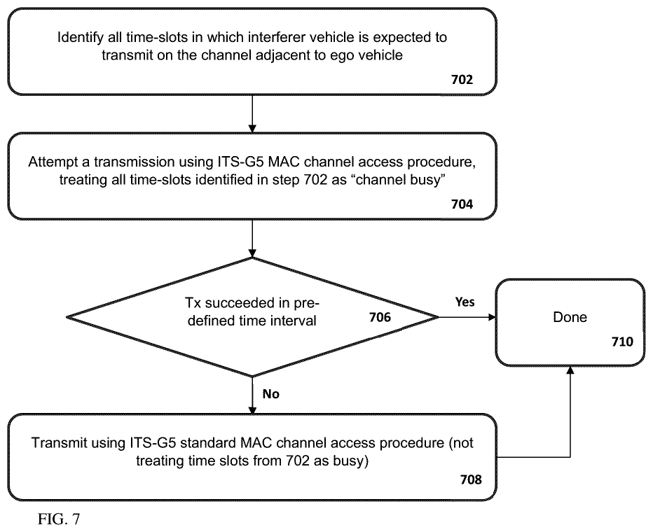

FIG. 7 illustrates in a flowchart sub-steps of step 506 of FIG. 5, when operating on the ITS-G5 channel. All steps are performed in (and by) the ego-vehicle. In step 702, the ego-vehicle identifies all time-slots in which an interferer vehicle is expected to transmit on the channel adjacent to ego vehicle, based on its past transmissions. In step 704, the ego-vehicle attempts a transmission using an ITS-G5 MAC channel access procedure, treating all time-slots identified in step 702 as “channel busy”. In step 706, a check is made to see whether a transmission was successful in a configurable pre-defined interval (for example <100 ms). If yes, the operation moves to step 710 where it ends. Otherwise the operation moves to step 708. In step 708, the ego vehicle transmits according to the standard defined transmission procedure, disregarding the time-slots identified in step 702. This procedure always ends with a transmission and transitions to step 710, where it ends.

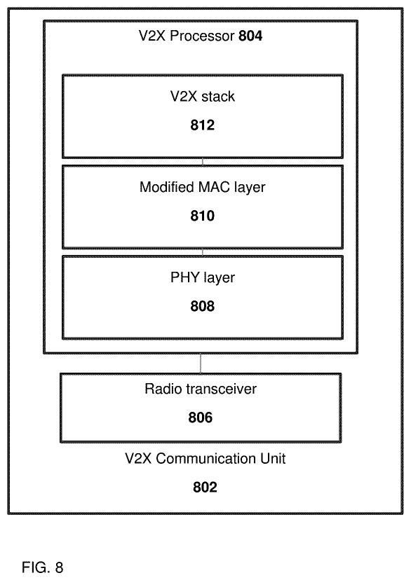

FIG. 8 shows a block diagram of an embodiment of an apparatus (system) numbered for performing a method disclosed herein. The apparatus is essentially a modified V2X communication unit 802 and comprises a V2X processor 804 and a radio transceiver 806 operatively coupled with one another. V2X processor 804 includes a PHY layer 808, a modified MAC layer 810 and a V2X stack 812. The “modified” aspect of V2X communication unit 802 is relative to known V2X communication units, and reflects mainly the functions of the modified MAC layer.

PHY layer 808 is configured to send and receive radio signals to/from radio transceiver 806 and to perform PHY transport layer functions, including delivering received messages to modified MAC layer 810. V2X stack 812 is configured to identify safety critical vehicles and expected interferers and report to modified MAC layer 810.

Modified MAC layer 810 is “modified” vs. known MAC layers in the sense that it uses the information from V2X stack 812 to execute the steps described in FIG. 6 or FIG. 7, depending on whether it is configured to operate on the C-V2X channel or the ITS-G5 channel. At least some of those steps are inventive vs. the known art. It also performs all the standard MAC layer functions. Since at least some method steps are inventive, the configuration of the modified MAC layer and the modified MAC layer itself are similarly inventive.

Specifically, V2X stack 812 identifies a safety-critical vehicle in the vicinity of the ego-vehicle and identifies interferers in proximity to the safety-critical vehicle. Modified MAC layer 810 estimates transmission time slots of each identified interferer based on past transmissions of the respective identified interferer, and transmits in a way that the transmission would not overlap with transmission from any of the identified interferers (i.e. transmits in a time slot that minimizes the probability of an over-the-air collision with any of the identified interferers”.

Although the description above refers almost exclusively to interferer vehicles, it should be understood that vehicles represent only a particular example of an “interferer”, and that the methods disclosed herein are also applicable to interferers that are non-vehicles, for example motorbikes, road-side infrastructure such as traffic lights and road-works trailers, pedestrian hand-held devices such as smartphones, etc. It should be understood as well that a modified V2X communication unit disclosed herein may be installed for use by road users other than vehicles (for example bicycles, motorbikes, scooters, etc.).

Unless otherwise defined, all technical and scientific terms used herein have the same meaning as commonly understood by one of ordinary skill in the art. The materials, methods, and examples provided herein are illustrative only and not intended to be limiting.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. In a vehicle-to-everything (V2X) environment, a method comprising: by an ego-vehicle:
identifying a safety-critical vehicle in the vicinity of the ego-vehicle;
identifying interferers in proximity to the safety-critical vehicle;
estimating transmission time slots of each identified interferer based on past transmissions of the respective identified interferer; and
transmitting in a time slot that minimizes the probability of an over-the-air collision with any of the identified interferers and that maximizes the likelihood of successful reception by the safety-critical vehicle,
wherein the method is performed without violating a V2X standard, and whereby the method enhances transmission safety.

2. The method of claim 1, wherein the transmitting in a time slot that minimizes the probability of an over-the-air collision with any of the identified interferers includes scheduling a transmission time slot which does not overlap with the estimated interferer transmission time slots and transmitting in the scheduled transmission time slot.

3. The method of claim 1, wherein the transmission is on a C-V2X channel, and wherein the estimating the transmission slots of each identified interferer includes:
(i) identifying time slots during which each identified interferer is expected to transmit on the same channel as the ego-vehicle,
(ii) identifying all time slots during which each respective identified interferer is expected to transmit on a channel adjacent to the one on which the ego-vehicle transmits, based on past transmission times of the respective identified interferer,
(iii) identifying all possible transmission resources per a resource selection procedure, and
(iv) selecting an identified transmission resource while excluding slots identified in (i) and (ii).

4. The method of claim 1, wherein the transmission is on an ITS-G5 channel, and wherein
the estimating the transmission slots of each identified interferer includes:
identifying time slots during which each identified interferer is expected to transmit on the same channel as the ego-vehicle,
attempting a transmission using an ITS-G5 MAC channel access procedure, treating all identified time-slots as channel busy, and
checking whether the transmission was successful in a configurable pre-defined interval.

5. The method of claim 4, wherein, if the transmission was not successful in the configurable pre-defined interval, the transmitting in a time slot includes transmitting according to an ITS-G5 standard defined transmission procedure.

6. A vehicle-to-everything (V2X) communication unit installed in an ego-vehicle and comprising:
a radio transceiver for transmitting and receiving messages; and
a V2X processor operatively coupled with the radio transceiver, wherein the V2X processor includes a PHY layer, a modified MAC layer and a V2X stack, wherein the V2X stack is configured without violating a V2X standard to identify a safety-critical vehicle in the vicinity of the ego-vehicle and to identify interferers in proximity to the safety-critical vehicle, and wherein the modified MAC layer is configured to estimate transmission time slots of each identified interferer based on past transmissions of the respective identified interferer, and to transmit in a way that the transmission minimizes the probability of an over-the-air collision with any of the identified interferers and that maximizes the likelihood of successful reception by the safety-critical vehicle.

7. The V2X communication unit of claim 6, wherein the configuration of the modified MAC layer to estimate transmission time slots of each identified interferer based on past transmissions of the respective identified interferer, and to transmit in a way that minimizes the probability of an over-the-air collision with any of the identified interferers includes a configuration to schedule a transmission time slot which does not overlap with the estimated interferer transmission time slots and to transmit in the scheduled transmission time slot.

8. The V2X communication unit of claim 6, wherein the transmission is on a C-V2X channel, and wherein the configuration of the modified MAC layer to estimate the transmission slots of each identified interferer includes a configuration to
(i) identify time slots during which each identified interferer is expected to transmit on the same channel as the ego-vehicle,
(ii) identify all time slots during which each respective identified interferer is expected to transmit on a channel adjacent to the one on which the ego-vehicle transmits, based on past transmission times of the respective identified,
(iii) identify all possible transmission resources per a sensing based resource selection procedure, and select an identified transmission resource while excluding slots identified in (i) and (ii).

9. The V2X communication unit of claim 6, wherein the transmission is on an ITS-G5 channel, and wherein the configuration of the modified MAC layer to estimate the transmission slots of each identified interferer includes a configuration to identify time slots during which each identified interferer is expected to transmit on the same channel as the ego-vehicle, to attempt a transmission using an ITS-G5 MAC channel access procedure, treating all identified time-slots as channel busy, and to check whether the transmission was successful in a configurable pre-defined interval.

10. The V2X communication unit of claim 9, wherein, if the transmission was not successful in the configurable pre-defined interval, the configuration of the modified MAC layer to transmit in a time slot includes transmitting according to an ITS-G5 standard defined transmission procedure.
